(19) United States
(12) Patent Application Publication
(10) Pub. No.: US 2026/0028952 A1
(43) Pub. Date: Jan. 29, 2026

(54) VAPOR SEPARATOR TANK

(71) Applicant: MIKUNI CORPORATION, Tokyo (JP)

(72) Inventor: Takumi Oikawa, Odawara-shi (JP)

(21) Appl. No.: 19/230,393

(22) Filed: Jun. 6, 2025

(30) Foreign Application Priority Data
Jul. 26, 2024 (JP) 2024-121129

(51) Int. Cl. F02M 33/02; F02M 37/00

(52) U.S. Cl. CPC F02M 33/025; F02M 37/0076

(57) ABSTRACT

In a VST (vapor separator tank), a lower case is provided with a plurality of attachment portions attached to an engine (internal combustion engine) and drain piping for discharging liquid fuel from a fuel storage compartment. The lower case includes a first bottom surface portion including a lowermost surface, a second bottom surface portion formed in a position higher than the first bottom surface portion and supporting a pump, and a third bottom surface portion formed in a position higher than the first bottom surface portion and the second bottom surface portion. Disclosed embodiments provide a vapor separator tank in which the capacity of a fuel storage compartment is sufficiently secured, and which allows easy arrangement of other equipment and parts around the vapor separator tank while enabling easy design change.

### CROSS-REFERENCE TO RELATED APPLICATION(S)

The present application claims priority to Japanese patent application Serial No. 2024-121129, filed Jul. 26, 2024, the content of which is hereby incorporated by reference in its entirety.

### BACKGROUND OF THE INVENTION

### Field of the Invention

The present invention relates to a vapor separator tank.

### Description of the Related Art

Heretofore, a technology related to a vapor separator tank that separates gas from liquid fuel to be supplied to an internal combustion engine has been known. For example, Japanese Patent Laid-Open No. 2011-73630 describes a vapor separator tank in which a fuel storage compartment is formed inside a casing formed of a lower case forming the fuel storage compartment and an upper case closing an upper opening of the lower case.

### SUMMARY OF THE INVENTION

Incidentally, since a vapor separator tank is generally arranged near an internal combustion engine, a plurality of pipes and some of related equipment are often arranged therearound. Additionally, the vapor separator tank is provided with drain piping, portions for attaching to the internal combustion engine, and the like. Therefore, it is preferable to secure as much space as possible for arranging these components. At the same time, it is also necessary to secure the capacity of the vapor separator tank, and it is preferable that the capacity is easily changeable.

The present invention has been made in view of such issues, and aims to provide a vapor separator tank in which the capacity of a fuel storage compartment is sufficiently secured, and which allows easy arrangement of other equipment and parts or members thereof around the vapor separator tank while enabling easy design change.

A vapor separator tank according to embodiments of the present invention can be a vapor separator tank mounted on an outboard motor and separating gas from liquid fuel to be supplied to an internal combustion engine, the vapor separator tank including: a casing including a lower case and an upper case joined to each other and having a fuel storage compartment formed therein to store the liquid fuel; a pump pumping the liquid fuel stored in the fuel storage compartment; and a pressure regulator arranged in the fuel storage compartment and adjusting a discharge pressure of the pump to be constant, in which the lower case is provided with a plurality of attachment portions attached to the internal combustion engine and drain piping for discharging the liquid fuel from the fuel storage compartment, and the lower case includes a first bottom surface portion including a lowermost surface, a second bottom surface portion formed in a position higher than the first bottom surface portion and supporting the pump, and a third bottom surface portion formed in a position higher than the first bottom surface portion and the second bottom surface portion.

The drain piping may be provided below the second bottom surface portion.

The third bottom surface portion may be located on the front side of the outboard motor with respect to a first center line of the lower case and in a corner portion on the left or right side of the outboard motor with respect to a second center line of the lower case, the second center line being orthogonal to the first center line.

The third bottom surface portion may be located below the pressure regulator and at the side of the pump.

The third bottom surface portion may be located higher than a suction port of the pump.

According to the vapor separator tank of the present invention, it is possible to obtain a configuration in which the capacity and ease in design change of a fuel storage compartment is secured, and which allows easy arrangement of other equipment and parts or members of the vapor separator tank therearound.

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a side view schematically illustrating an outboard motor including a vapor separator tank according to an embodiment;

FIG. 2 is a plan view schematically illustrating the outboard motor;

FIG. 3 is a perspective view of the vapor separator tank as viewed from the obliquely upper side;

FIG. 4 is a perspective view of the vapor separator tank as viewed from the obliquely lower side;

FIG. 5 is a bottom view of the vapor separator tank;

FIG. 6 is a cross-sectional view of the vapor separator tank taken along line A-A of FIG. 5; and

FIG. 7 is a cross-sectional view of the vapor separator tank taken along a second center line of FIG. 5.

While the above-identified figures set forth one or more embodiments of the present invention, other embodiments are also contemplated as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE INVENTION

Hereinafter, an embodiment of the present invention will be described with reference to the drawings.

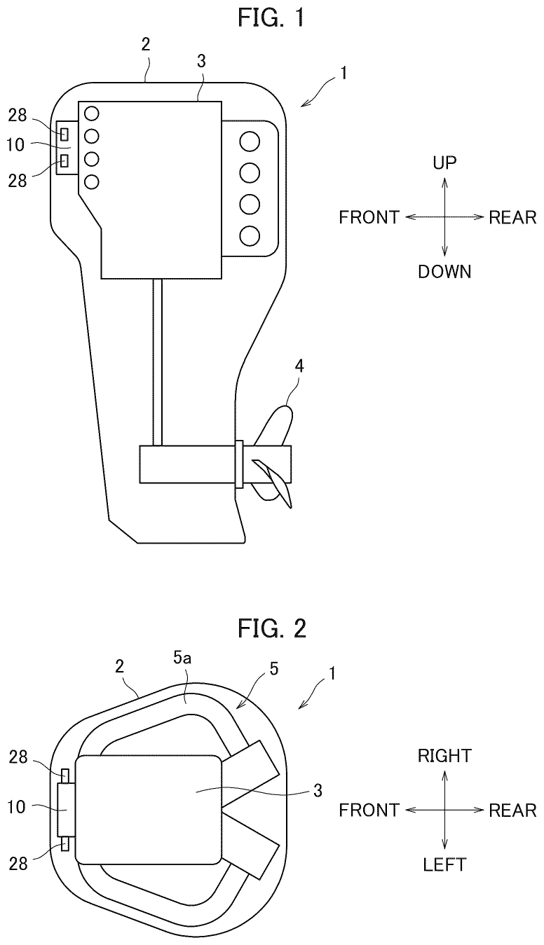

FIG. 1 is a side view schematically illustrating an outboard motor including a vapor separator tank according to the embodiment. FIG. 2 is a plan view schematically illustrating the outboard motor. Hereinbelow, configurations will be described on the basis of a front-rear direction, a left-right direction, and an up-down direction of a ship (not illustrated) on which an outboard motor 1 is mounted. The outboard motor 1 is mounted on the ship and rotates a propeller 4 by the motive force of a multi-cylinder engine (internal combustion engine) 3 mounted inside a main body case 2. As illustrated in FIG. 2, a plurality of intake pipes 5a included in an intake manifold 5 for drawing in air to the engine 3 are arranged to extend from a mixing body in the front-rear direction apart from a side surface of the engine 3 inside the main body case 2. Note that the plurality of intake pipes 5a are omitted from FIG. 1.

The outboard motor 1 includes a vapor separator tank 10 (referred to as “VST 10” below) having a gas-liquid separation function of temporarily storing liquid fuel to be supplied to the engine 3 and separating gas such as evaporated gas and bubbles in the liquid fuel. The VST 10 is connected between the engine 3 and a fuel tank (not illustrated) storing liquid fuel, and is supplied with liquid fuel from the fuel tank by a low-pressure pump (not illustrated). In the present embodiment, the VST 10 is attached to a front surface of the engine 3. Note that the VST 10 may be arranged in a space between the side surface of the engine 3 and the intake manifold 5.

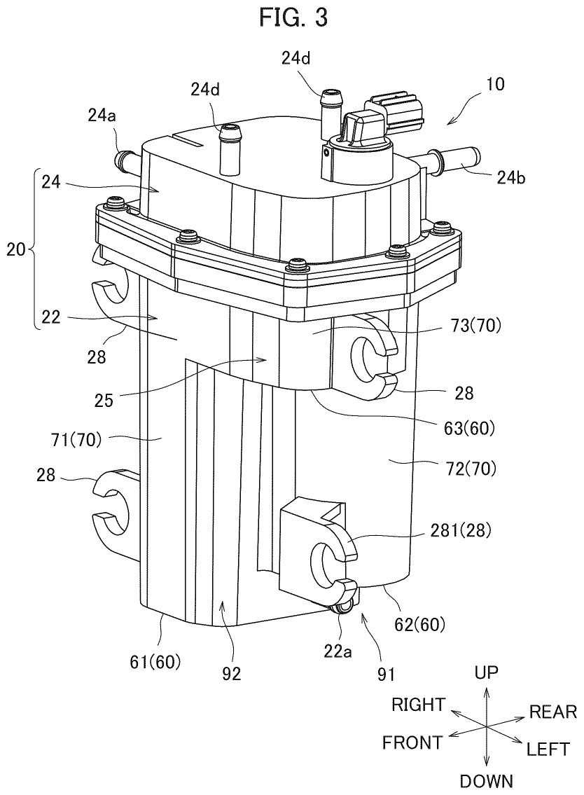

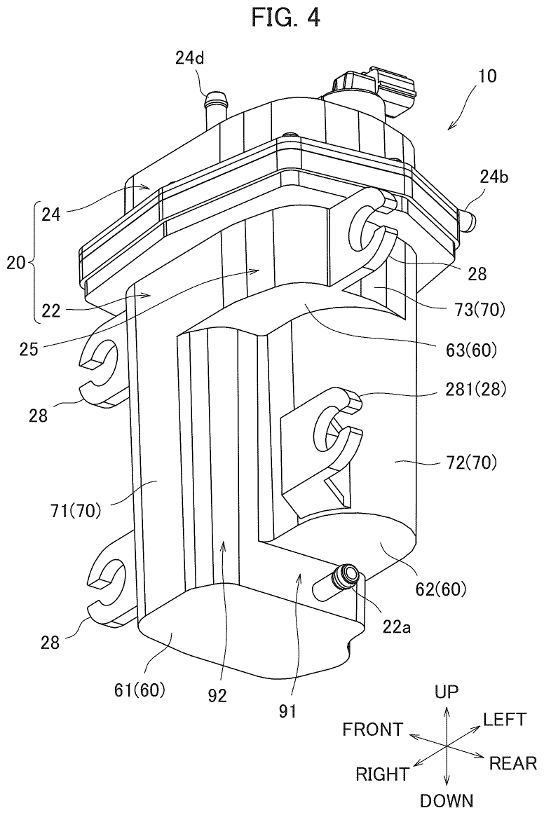

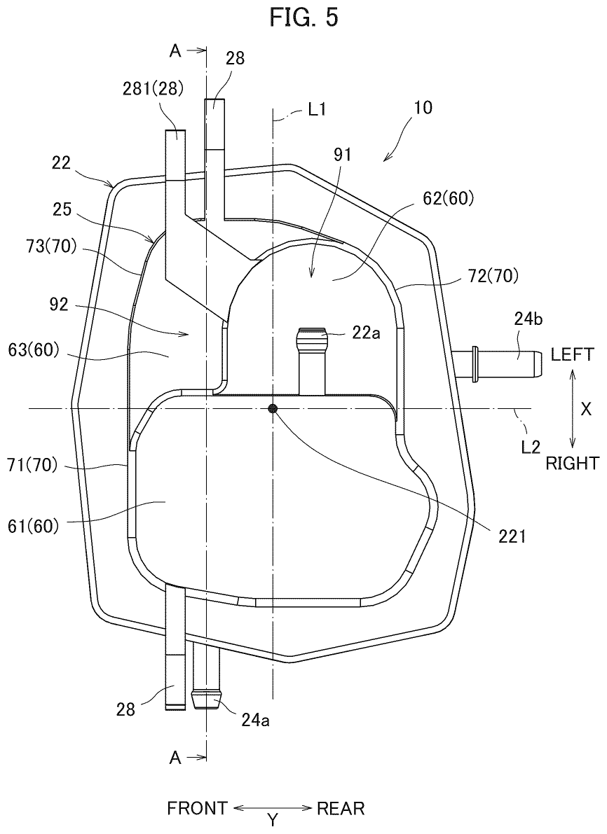

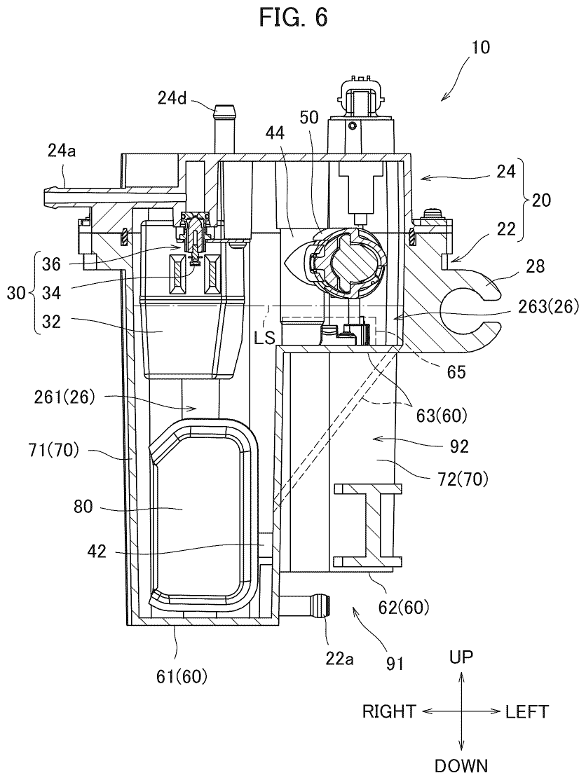

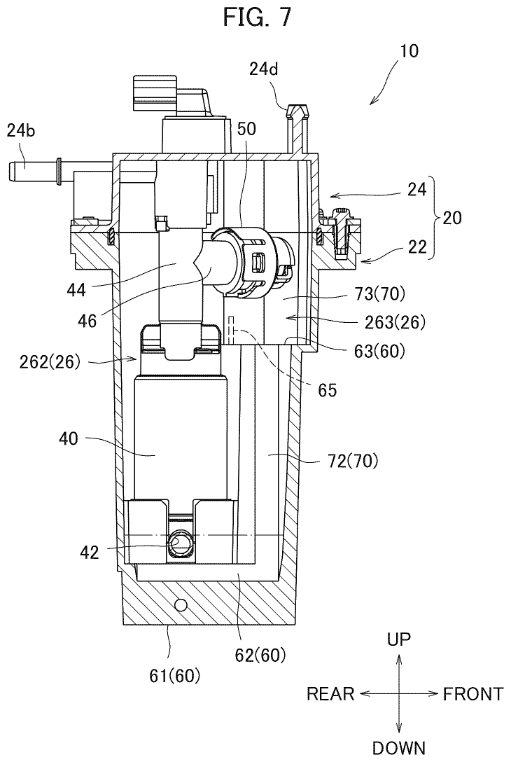

Hereinafter, a specific configuration of the VST 10 will be described with reference to FIGS. 3 to 7. FIG. 3 is a perspective view of the VST 10 as viewed from the obliquely upper side. FIG. 4 is a perspective view of the VST 10 as viewed from the obliquely lower side. FIG. 5 is a bottom view of the VST 10. FIG. 6 is a cross-sectional view of the VST 10 taken along line A-A of FIG. 5. FIG. 7 is a cross-sectional view of the VST 10 taken along a second center line L2 of FIG. 5. As illustrated in FIGS. 6 and 7, the VST 10 includes a casing 20, a float mechanism 30, a pump 40, and a pressure regulator 50.

The casing 20 includes a lower case 22 and an upper case 24. The lower case 22 forms a fuel storage compartment 26 that stores liquid fuel. The fuel storage compartment 26 is a space surrounded by a bottom surface portion 60 of the lower case 22 and a side wall portion 70 extending upward from the bottom surface portion 60. Drain piping 22a for discharging fuel when not using the internal combustion engine for a long time during maintenance or off-season is formed in a lower portion of the lower case 22. Moreover, a plurality of attachment portions 28 for attaching the VST 10 to the engine 3 are formed in the lower case 22. A total of four attachment portions 28 extend from an outer surface of the lower case 22 on the upper right side, the upper left side, the lower right side, and the lower left side. Hereinafter, of the plurality of attachment portions 28, the one provided on the lower left side will be referred to as “attachment portion 281”.

The upper case 24 is a lid-shaped member closing an upper opening of the lower case 22, and is joined to the lower case 22 using a fastener. The upper case 24 is provided with a fuel inlet 24a to which liquid fuel from the fuel tank flows in, and a fuel outlet 24b from which liquid fuel to be supplied to the engine 3 side flows out. The fuel outlet 24b is connected to a discharge port of the pump 40 described later. Additionally, the upper case 24 is provided with two air vents 24d that discharge gas such as evaporated fuel and bubbles from the liquid fuel to the outside.

The float mechanism 30 includes a float 32, a coupling member 34, and a float valve 36. The float 32 is swingably supported by the upper case 24 via the coupling member 34 partially illustrated in FIG. 6, and is floated in liquid fuel inside the fuel storage compartment 26. The float 32 moves with upward and downward movement of a liquid surface LS of the liquid fuel indicated by a dot-dash line in FIG. 6. Additionally, the coupling member 34 is configured to move up and down together with the float valve 36 provided in a channel communicating with the fuel inlet 24a.

With this configuration, when the amount of liquid fuel inside the fuel storage compartment 26 is less than a predetermined reference value, the float 32 is located below a predetermined position, whereby a part of the coupling member 34 pushes down a valve body of the float valve 36 to open the float valve 36. As a result, liquid fuel flows into the fuel storage compartment 26 from the fuel inlet 24a. On the other hand, when the amount of liquid fuel inside the fuel storage compartment 26 is equal to or more than the reference value, the float 32 moves to the upper side of the predetermined position, whereby a part of the coupling member 34 pushes up the valve body of the float valve 36 to close the float valve 36. As a result, the flow of liquid fuel into the fuel storage compartment 26 from the fuel inlet 24a is restricted. Accordingly, the amount of liquid fuel inside the fuel storage compartment 26 is adjusted to be constant.

As illustrated in FIG. 7, the pump 40 is a high-pressure pump mounted inside the casing 20 and pumping liquid fuel stored in the fuel storage compartment 26. The pump 40 is a vertical pump arranged inside a pump accommodation portion 262 described later, and is provided with a suction port 42 in its lower portion and a discharge port in its upper portion. A filter 80 (FIG. 6) that filters the liquid fuel inside the fuel storage compartment 26 is connected to the suction port 42 of the pump 40. On the other hand, the discharge port of the pump 40 is connected to the fuel outlet 24b formed in the upper case 24 via a discharge pipe portion 44. The liquid fuel discharged from the pump 40 is guided to the fuel outlet 24b via the discharge pipe portion 44 and pumped to the engine 3 side. Additionally, in an intermediate portion of the discharge pipe portion 44, the pressure regulator 50 is connected via a relief pipe portion 46 extending horizontally from the discharge pipe portion 44.

The pressure regulator 50 includes a valve body, a valve seat portion, a spring, and other components (not illustrated) in a substantially cylindrical case, and opens in response to the increase in pressure of fuel flowing into the relief pipe portion 46 to return excess fuel to the fuel storage compartment 26. With this configuration, the discharge pressure of the pump 40, that is, the pressure of liquid fuel to be supplied to the engine 3, is adjusted to be constant.

Next, details of the shape of the VST 10 will be described. In the following description, of the horizontally extending center lines of the casing 20 (lower case 22) illustrated in FIG. 5, one is referred to as “first center line L1”, and the other is referred to as “second center line L2” as appropriate. In addition, a direction along the first center line L1 is referred to as “first direction X” and a direction along the second center line L2 is referred to as “second direction Y” as appropriate. In the present embodiment, the first direction X is the longer direction of the casing 20 (lower case 22) and the left-right direction of the outboard motor 1, and the second direction Y is the shorter direction of the casing 20 (lower case 22) and the front-rear direction of the outboard motor 1. Note that the relationship between the first direction X and second direction Y, the longer direction and shorter direction, and the left-right direction and front-rear direction is not limited to this example.

The lower case 22 has the bottom surface portion 60 including a first bottom surface portion 61, a second bottom surface portion 62, and a third bottom surface portion 63, and the side wall portion 70 including a first side wall portion 71, a second side wall portion 72, and a third side wall portion 73 extending upward from the bottom surface portion 60. The first bottom surface portion 61 is a bottom surface portion including the lowermost surface of the entire VST 10. As illustrated in FIG. 5, the first bottom surface portion 61 is formed in about half the size of the fuel storage compartment 26 in the first direction X. As illustrated in FIGS. 3 and 6, the first side wall portion 71 extends from the first bottom surface portion 61. Together with the first side wall portion 71, the first bottom surface portion 61 forms a main storage portion 261 which is a main space of the fuel storage compartment 26. That is, the first bottom surface portion 61 forms a main bottom surface portion of the fuel storage compartment 26.

As illustrated in FIG. 5, the second bottom surface portion 62 is formed in about half the size of the fuel storage compartment 26 at a position slightly shifted from the first bottom surface portion 61 in the first direction X. As illustrated in FIGS. 3 and 7, the second side wall portion 72 extends from the second bottom surface portion 62. Together with the second side wall portion 72, the second bottom surface portion 62 forms the pump accommodation portion 262 accommodating the pump 40 in the fuel storage compartment 26, and supports the pump 40. The second bottom surface portion 62 is formed in a position higher than the first bottom surface portion 61.

As illustrated in FIG. 5, the third bottom surface portion 63 is formed in a corner portion 25 of the lower case 22. The corner portion 25 is a range from the side wall portion 70 (third side wall portion 73) of the lower case 22 in the part forming the fuel storage compartment 26 toward a center 221 in one of four regions partitioned by the first center line L1 and the second center line L2 when the VST 10 is viewed in the up-down direction. More specifically, as illustrated in FIG. 5, the third bottom surface portion 63 is formed in a position shifted from the first bottom surface portion 61 in the first direction X and shifted from the second bottom surface portion 62 in the second direction Y. That is, the third bottom surface portion 63 is arranged in a position where its center is shifted with respect to both the first center line L1 and the second center line L2. Note, however, that as illustrated in FIG. 5, the third bottom surface portion 63 is not necessarily formed so that its entire surface does not overlap the first center line L1 and the second center line L2, and the vicinity of an end portion thereof may exceed the first center line L1 and the second center line L2. The size of the third bottom surface portion 63 is about one fourth of the fuel storage compartment 26.

In the present embodiment, as illustrated in FIG. 7, the third bottom surface portion 63 is provided at the side of the pump 40 on a side different from the side on which the suction port 42 is formed. Moreover, the third bottom surface portion 63 extends along the horizontal direction below the pressure regulator 50. With this configuration, when the third bottom surface portion 63 is located above the liquid surface LS, the third bottom surface portion 63 can receive liquid fuel from the pressure regulator 50. As a result, it is possible to prevent dripping of liquid fuel onto the liquid surface LS to suppress generation of bubbles in the liquid fuel, and suppress suction of liquid fuel containing bubbles into the pump 40. Accordingly, it is more preferable to provide the third bottom surface portion 63 near the pressure regulator 50 at a position higher than the level of the liquid surface LS to be maintained by the float mechanism 30. Then, the third bottom surface portion 63 is located higher than the first bottom surface portion 61 and the second bottom surface portion 62. As illustrated in FIGS. 6 and 7, the third side wall portion 73 extends from the third bottom surface portion 63. Together with the third side wall portion 73, the third bottom surface portion 63 forms an auxiliary storage portion 263 which is a part of the fuel storage compartment 26.

With the above configuration, as illustrated in FIGS. 3 and 4, a first space 91 is formed below the second bottom surface portion 62 around the VST 10. As a result, the first space 91 can be used to pull out the drain piping 22a horizontally, or more specifically, in the left-right direction of the outboard motor 1 from the first side wall portion 71. Accordingly, compared to a case where the drain piping 22a is pulled down from the first bottom surface portion 61 or pulled out in the front-rear direction from the first side wall portion 71, the VST 10 can be reduced in size.

Additionally, around the VST 10, a second space 92 is formed below the third bottom surface portion 63 in a position corresponding to the corner portion 25. Thus, by using a part of the corner portion 25 that tends to have a relatively large excess space inside the fuel storage compartment 26 as the second space 92, other equipment and parts such as unillustrated pipings of the outboard motor 1 and components of the intake manifold 5 can be arranged more easily. Alternatively, it is possible to downsize the main body case 2 of the outboard motor 1 by the size of the second space 92. Since the VST 10 of the present embodiment is arranged in front of the engine 3, its length in the horizontal direction, or more specifically, in the left-right direction of the outboard motor 1 is often limited, and the VST 10 has a generally square shape as a whole. Even with such a shape, the second space 92 makes it easier to arrange other equipment and parts. At the same time, capacity can be secured in regions of the fuel storage compartment 26 other than the corner portion 25, so that reduction of the capacity of the VST 10 as a whole can be suppressed.

Moreover, since the second space 92 is formed in the corner portion 25, the second space 92 can be used to more freely arrange the attachment portion 281 extending in the horizontal direction, or more specifically, the left-right direction of the outboard motor 1. The attachment portion 281 is provided in the vicinity of the heavy pump 40 that frequently causes vibration, and is easily affected by the vibration. According to the present embodiment, the attachment portion 281 can be provided in a desired position in the second space 92 while considering the influence of vibration.

Furthermore, in the present embodiment, the third bottom surface portion 63 is formed at least higher than an upper end position (dot-dash line position in FIG. 7) of the suction port 42 of the pump 40. Accordingly, the auxiliary storage portion 263 is located higher than the suction port 42. Since liquid fuel is difficult to suck in from below the suction port 42 in the fuel storage compartment 26, it is preferable to increase the capacity of the fuel storage compartment 26 by increasing the area above the suction port 42. In the present embodiment, the auxiliary storage portion 263 is located higher than the suction port 42, so that the capacity of the fuel storage compartment 26 can be secured more effectively.

In addition, by adjusting the height of the third bottom surface portion 63, the capacity of the fuel storage compartment 26 can be adjusted. The capacity of the fuel storage compartment 26 may be changed from the initial design value depending on other design elements such as components and shape of parts when mounting the VST 10 onto the outboard motor 1. It is not easy to change only the capacity of the fuel storage compartment 26 after the specification of the VST 10 including the other design elements described above is determined. That is, it is not preferable to increase the fuel storage compartment 26 toward the lower side of the suction port 42 of the pump 40 as described above. Meanwhile, an increase in the upper opening of the lower case 22 is a large design change, and the number of man-hours spent on research also increases. In the present embodiment, the capacity of the fuel storage compartment 26 can be adjusted only by adjusting the height of the third bottom surface portion 63 located in the corner portion 25 easily usable as excess space. Hence, even after the other specifications of the VST 10 is determined, design change of the capacity of the fuel storage compartment 26 can be performed easily. Note that since it is possible to respond to changes in capacity by changing only a part of the mold used to manufacture the lower case 22, it is preferable to prepare beforehand a mold in which the part for forming the third bottom surface portion 63 is replaceable.

As described above, in the VST (vapor separator tank) 10 of the embodiment, the lower case 22 is provided with the plurality of attachment portions 28 extending from the outer surface to be attached to the engine (internal combustion engine) 3 and the drain piping 22a for discharging liquid fuel from the fuel storage compartment 26. The lower case 22 includes the first bottom surface portion 61 including the lowermost surface, the second bottom surface portion 62 formed in a position higher than the first bottom surface portion 61 and supporting the pump 40, and the third bottom surface portion 63 formed in a position higher than the first bottom surface portion 61 and the second bottom surface portion 62.

With this configuration, as described above, the first space 91 below the second bottom surface portion 62 and the second space 92 below the third bottom surface portion 63 can be used to arrange other equipment and parts, or members of the VST 10 such as the drain piping 22a and the attachment portion 281. Additionally, by adjusting the height of the third bottom surface portion 63, the capacity of the fuel storage compartment 26 and ease in changing the capacity can be secured.

Moreover, the drain piping 22a is provided below the second bottom surface portion 62. With this configuration, the drain piping 22a can be arranged within the range of the first space 91 to reduce the VST 10 in size.

In addition, the third bottom surface portion 63 is arranged on the front side of the outboard motor 1 with respect to the first center line L1 of the lower case 22 and in the corner portion 25 on the left side of the outboard motor 1 with respect to the second center line L2 of the lower case 22, the second center line L2 being orthogonal to the first center line L1. With this configuration, it is possible to arrange other equipment and parts or the attachment portion 281 in the front part of the outboard motor 1 in the second space 92, or to downsize the outboard motor 1 by the size of the second space 92. Additionally, the attachment portion 281 can be arranged more freely. Note that the third bottom surface portion 63 may be arranged in the corner portion on the right side of the outboard motor 1 with respect to the second center line L2.

Moreover, the third bottom surface portion 63 is arranged below the pressure regulator 50 at the side of the pump 40. With this configuration, liquid fuel from the pressure regulator 50 can be easily received by the third bottom surface portion 63, and generation of bubbles in the liquid fuel can be suppressed. Additionally, by securing the second space 92 at the side of the pump 40, it is possible to provide the attachment portion 281 in a position in consideration of the vibration of the pump 40.

Additionally, the third bottom surface portion 63 is located higher than the suction port 42 of the pump 40. With this configuration, the capacity of the fuel storage compartment 26 can be secured by the auxiliary storage portion 263.

In the present embodiment, the third bottom surface portion 63 extends along the horizontal direction. Note, however, that the third bottom surface portion 63 may extend obliquely toward the center of the fuel storage compartment 26 from the pressure regulator 50 side toward the lower side as indicated by broken lines in FIG. 6. As a result, generation of bubbles in the liquid fuel from the pressure regulator 50 can be suppressed even more effectively. Additionally, by adjusting the inclination angle and the like of the third bottom surface portion 63, it is possible to straighten the flow so that liquid fuel from the pressure regulator 50 containing bubbles can be kept from flowing toward the suction port 42 of the pump 40.

Moreover, as schematically illustrated by a broken line in FIGS. 6 and 7, for example, a vertical wall portion 65 extending upward from the third bottom surface portion 63 may be provided. The vertical wall portion 65 is provided in a position where it suppresses flow of liquid fuel from the pressure regulator 50 toward the suction port 42 of the pump 40. The vertical wall portion 65 is provided in the vicinity of an end portion of the third bottom surface portion 63 between the pressure regulator 50 and the pump 40, for example. Alternatively, a plurality of fins, lattice-shaped portions, or the like for straightening the flow and preventing bubbles in the liquid fuel from the pressure regulator 50 may be provided in the third bottom surface portion 63.

Although the embodiment has been described above, the mode of the present invention is not limited to this embodiment. For example, in the present embodiment, the third bottom surface portion 63 is provided in a position higher than the suction port 42 of the pump 40 at the side of the pump 40 on a side different from the side on which the suction port 42 is formed and below the pressure regulator 50. Note, however, that the third bottom surface portion 63 may be provided in another part of the lower case 22 as long as it is higher than the first bottom surface portion 61 and the second bottom surface portion 62. For example, the third bottom surface portion 63 is preferably formed around the pump 40 and preferably formed in one corner portion of the lower case 22.

### REFERENCE SIGNS LIST

1 outboard motor
3 engine (internal combustion engine)
10 vapor separator tank (VST)
20 casing
22 lower case
22a drain piping
24 upper case
25 corner portion
26 fuel storage compartment
28, 281 attachment portion
30 float mechanism
40 pump
42 suction port
50 pressure regulator
60 bottom surface portion
61 first bottom surface portion
62 second bottom surface portion
63 third bottom surface portion
70 side wall portion
80 filter
91 first space
92 second space

Although the present invention has been described with reference to preferred embodiments, workers skilled in the art will recognize that changes may be made in form and detail without departing from the spirit and scope of the invention.

What is claimed is:

1. A vapor separator tank mounted on an outboard motor and separating gas from liquid fuel to be supplied to an internal combustion engine, the vapor separator tank comprising:
a casing including a lower case and an upper case joined to each other and having a fuel storage compartment formed therein to store the liquid fuel;
a pump pumping the liquid fuel stored in the fuel storage compartment; and
a pressure regulator arranged in the fuel storage compartment and adjusting a discharge pressure of the pump to be constant, wherein
the lower case is provided with a plurality of attachment portions attached to the internal combustion engine and drain piping for discharging the liquid fuel from the fuel storage compartment, and
the lower case includes a first bottom surface portion including a lowermost surface, a second bottom surface portion formed in a position higher than the first bottom surface portion and supporting the pump, and a third bottom surface portion formed in a position higher than the first bottom surface portion and the second bottom surface portion.

2. The vapor separator tank according to claim 1, wherein the drain piping is provided below the second bottom surface portion.

3. The vapor separator tank according to claim 1, wherein the third bottom surface portion is located on a front side of the outboard motor with respect to a first center line of the lower case and in a corner portion on a left or right side of the outboard motor with respect to a second center line of the lower case, the second center line being orthogonal to the first center line.

4. The vapor separator tank according to claim 1, wherein the third bottom surface portion is located below the pressure regulator and at a side of the pump.

5. The vapor separator tank according to claim 1, wherein the third bottom surface portion is located higher than a suction port of the pump.
